(19) United States
(12) Patent Application Publication
(10) Pub. No.: US 2015/0069035 A1
(43) Pub. Date: Mar. 12, 2015

(54) TIRE INFLATION SYSTEM FOR ENGINE DRIVEN WELDER

(71) Applicant: LINCOLN GLOBAL, INC., CITY OF INDUSTRY, CA (US)

(72) Inventor: SAMIR F. FARAH, BROADVIEW HEIGHTS, OH (US)

(73) Assignee: LINCOLN GLOBAL, INC., CITY OF INDUSTRY, CA (US)

(21) Appl. No.: 14/091,546

(22) Filed: Nov. 27, 2013

Related U.S. Application Data
(60) Provisional application No. 61/876,797, filed on Sep. 12, 2013.

(51) Int. Cl. B23K 9/10; B23K 9/32

(52) U.S. Cl. CPC B23K 9/1006; B23K 9/327
USPC 219/134

(57) ABSTRACT

The invention described herein generally pertains to a system and method for an air compressor system integrated into an engine welder. In particular, an air compressor system can be powered by at least a motor of an engine driven welder such that the engine driven welder can provide enhanced capabilities related to use of stored compressed air. The air compressor system can be stored into a portion of a housing of the engine driven welder, wherein the housing is a compartment that allows for concealment of the air compressor system unless needed by a user. The stored compressed air can be utilized, for instance, to drive a pneumatic device or inflate a tire.

### CROSS-REFERENCE TO RELATED APPLICATIONS

This application claims the benefit of priority to U.S. Provisional Application Ser. No. 61/876,797, filed Sep. 12, 2013, and entitled “TIRE INFLATION SYSTEM FOR ENGINE DRIVEN WELDER.” The entirety of the aforementioned application is incorporated herein by reference.

### TECHNICAL FIELD

The invention described herein pertains generally to welding equipment, and more particularly to integrating an air compressor into a welding machine.

### BACKGROUND OF THE INVENTION

Frequently, welding is required where supply power may not be readily available. As such, the welding power supply may be an engine driven welding power supply incorporating a generator. The generator may supply power to the welder as well as to other power tools as may be needed on site. As different applications require different versions of welders and power tools, the trailer may be designed to carry one of many different types of welding power supplies.

Traditional welding-type apparatus can be broken into two basic categories. The first category receives operational power from transmission power receptacles, also known as static power. The second is portable or self-sufficient, stand alone welders having internal combustion engines, also known as rotating power. While in many settings conventional static power driven welders are preferred, engine driven welders enable welding-type processes where static power is not available. Rotating power driven welders operate by utilizing power generated from engine operation. As such, engine driven welders and welding-type apparatus allow portability and thus fill an important need.

Static powered welders initiate the weld process by way of a trigger on a hand-held torch or with an electrically charged stick connected to a charged electrode.

Rotating power driven welders operate similarly, as long as the engine is running. If the engine is shut down, there is typically no residual power to create an arc. To once again weld, the engine must be started and run at operational speed to produce the arc. Therefore, it is simply not possible to manually start and stop the engine between each and every break in the welding process. Further, even during longer periods, operators may find it easier to let the engine run because of distance to the engine, a misconception that it is better for the engine, or just out of habit.

### SUMMARY OF THE INVENTION

In accordance with the present invention, there is provided a welding device that includes at least one of a motor-driven welder assembly including a motor that is a power source for the welding device to perform a welding operation; an air compressor system that generates and stores a portion of compressed air in a reservoir, wherein the air compressor system is powered by at least the motor; a nozzle coupled to a hose that connects to the reservoir for delivery of the portion of compressed air; and a regulator component that is configured to manage an amount of the portion of compressed air stored in the reservoir.

In accordance with the present invention, there is provided a welding system that includes a motor-driven welder assembly including a motor that is a power source for the welding device to perform a welding operation and an internal compartment that houses an air compressor system. The air compressor system includes a reservoir that stores a portion of compressed air, an intake that receives a portion of ambient air, a crankcase with one or more pistons, means for driving the one or more pistons. a hose with a first end and a second end opposite the first end, the first end is coupled to the reservoir, and a a nozzle coupled to the second end for delivery of the portion of compressed air.

In accordance with the present invention, there is provided a welding device that includes at least the following: a trailer incorporating a trailer hitch, a trailer frame, and a payload region; an adjustable stand on a front end of the trailer, wherein the adjustable stand is configured to adjust a height of the front end of the trailer; an engine driven welder secured to the payload region; a motor-driven welder assembly including a motor that is a power source for the engine driven welder to perform a welding operation; an internal compartment that houses an air compressor system; the air compressor system that includes: a reservoir that stores a portion of compressed air, an intake that receives a portion of ambient air, a crankcase with one or more pistons, means for driving the one or more pistons, and means for delivering the portion of compressed air for inflation of a tire or driving a pneumatic device.

These and other objects of this invention will be evident when viewed in light of the drawings, detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 is a block diagram illustrating a welding device that includes a motor as a power source;

FIG. 2 is a block diagram illustrating a welding device;

FIG. 3 is a block diagram illustrating a welding device affixed to a trailer for mobility;

FIG. 4A is a block diagram illustrating a welding device;

FIG. 4B is a block diagram illustrating a welding device;

FIG. 5 is a diagram of an embodiment of a welder with an integrated air compressor powered by at least a portion of a power source of the welder;

FIGS. 6A and 6B illustrate embodiments including alternative positioning for an air compressor system for a welder; and

FIGS. 7A and 7B illustrate embodiments of an air compressor system with cutaway portions to depict various aspects of the air compressor apparatus.

### DETAILED DESCRIPTION OF THE INVENTION

Embodiments of the invention relate to methods and systems that generally relate to an air compressor system integrated into an engine welder. In particular, an air compressor system can be powered by at least a motor of an engine driven welder such that the engine driven welder can provide enhanced capabilities related to use of stored compressed air. The air compressor system can be stored into a portion of a housing of the engine driven welder, wherein the housing is a compartment that allows for concealment of the air compressor system unless needed by a user. The stored compressed air can be utilized, for instance, to drive a pneumatic device or inflate a tire. Further, an adjustment device allows a user setting to specify a target air pressure for delivery of stored compressed air. Moreover, a regulator component can manage an amount of stored compressed air in a reservoir in order to ensure the reservoir of the air compressor system is maintained within a safe pounds per square inch (PSI) range.

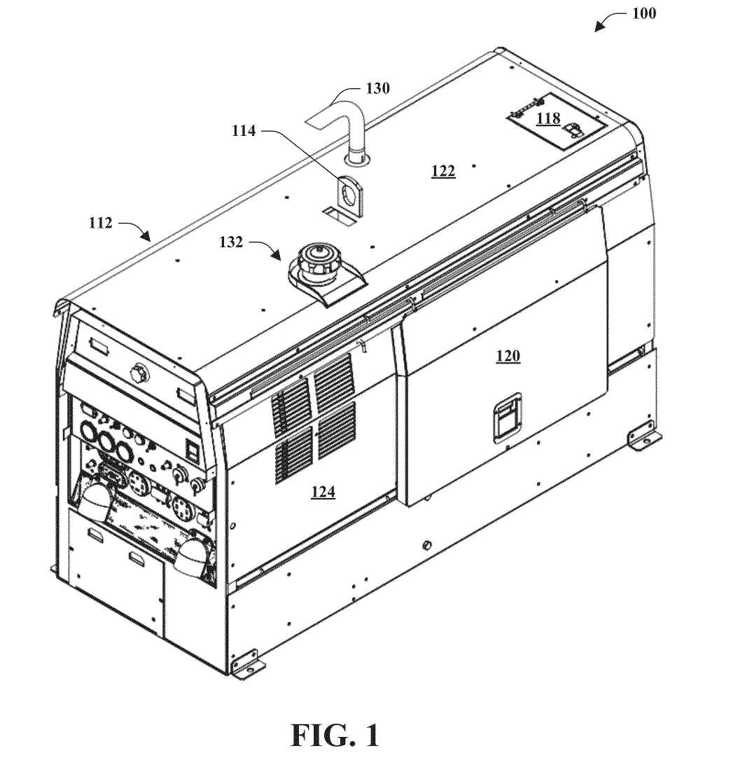

The subject innovation can be used with any suitable engine-driven welder, engine-driven welding system, engine-driven welding apparatus, a welding system powered by an engine, a welding system powered by a battery, a welding system powered by an energy storage device, a hybrid welder (e.g., a welding device that includes an engine driven power source and an energy storage device or batter), or a combination thereof. It is to be appreciated that any suitable system, device, or apparatus that can perform a welding operation can be used with the subject innovation and such can be chosen with sound engineering judgment without departing from the intended scope of coverage of the embodiments of the subject invention. The engine driven welder can include a power source that can be used in a variety of applications where outlet power is not available or when outlet power will not be relied on as the sole source of power including portable power generation, backup power generation, heating, plasma cutting, welding, and gouging. The example discussed herein relates to welding operations, such as, arc welding, plasma cutting, and gouging operations. It is to be appreciated that a power source can generate a portion of power, wherein the portion of power is electrical power. It is to be appreciated that “power source” as used herein can be a motor, an engine, a generator, an energy storage device, a battery, a component that creates electrical power, a component that converts electrical power, or a combination thereof. By way of example and not limitation, FIGS. 1-4 illustrate welding systems or devices that can be utilized with the subject innovation. It is to be appreciated that the following welding systems are described for exemplary purposes only and are not limiting on the welding systems that can utilize the subject innovation or variations thereof.

FIG. 1 illustrates a welding device 100. The welding device 100 includes a housing 112 which encloses the internal components of the welding device. Optionally, the welding type device 100 includes a loading eyehook 114 and/or fork recesses. The loading eyehook 114 and the fork recesses facilitate the portability of the welding device 100. Optionally, the welding-type device 100 could include a handle and/or wheels as a means of device mobility. The housing 112 also includes a plurality of access panels 118, 120. Access panel 118 provides access to a top panel 122 of housing 112 while access panel 120 provides access to a side panel 124 of housing 112. A similar access panel is available on an opposite side. These access panels 118, 120, provide access to the internal components of the welding device 100 including, for example, an energy storage device (not shown) suitable for providing welding-type power. An end panel includes a louvered opening to allow for air flow through the housing 112.

The housing 112 of the welding-type device 100 also houses an internal combustion engine. The engine is evidenced by an exhaust port 130 and a fuel port 132 that protrude through the housing 112. The exhaust port 130 extends above the top panel 122 of the housing 112 and directs exhaust emissions away from the welding-type device 100. The fuel port 132 preferably does not extend beyond the top panel 122 or side panel 124. Such a construction protects the fuel port 132 from damage during transportation and operation of the welding-type device 100.

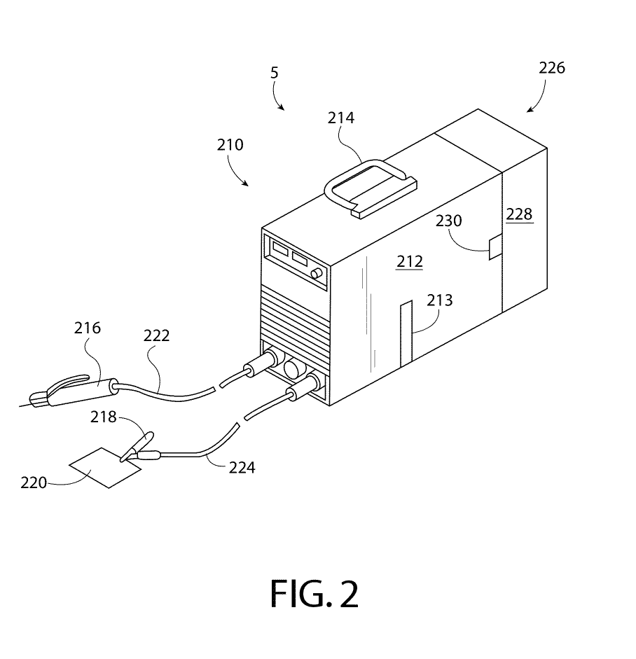

Referring now to FIG. 2, a perspective view of a welding apparatus 205 that can be utilized with the subject innovation. Welding apparatus 205 includes a power source 210 that includes a housing 212 enclosing the internal components of power source 210. As will be described in greater detail below, housing 212 encloses control components 213. Optionally, welding device 210 includes a handle 214 for transporting the welding system from one location to another. To effectuate the welding process, welding device 210 includes a torch 216 as well as a grounding clamp 218. Grounding clamp 218 is configured to ground a workpiece 220 to be welded. As is known, when torch 216 is in relative proximity to workpiece 220, a welding arc or cutting arc, depending upon the particular welding-type device, is produced. Connecting torch 216 and grounding clamp 218 to housing 212 is a pair of cables 222 and 224, respectively.

The welding arc or cutting arc is generated by the power source by conditioning raw power received from an interchangeable energy storage device 226. In a preferred embodiment, energy storage device 226 is a battery. Energy storage device 226 is interchangeable with similarly configured batteries. Specifically, energy storage device 226 is encased in a housing 228. Housing 228 is securable to the housing of welding device 210 thereby forming welding-type apparatus 205. Specifically, energy storage device 226 is secured to power source 210 by way of a fastening means 230. It is contemplated that fastening means 230 may include a clip, locking tab, or other means to allow energy storage device 226 to be repeatedly secured and released from power source 210.

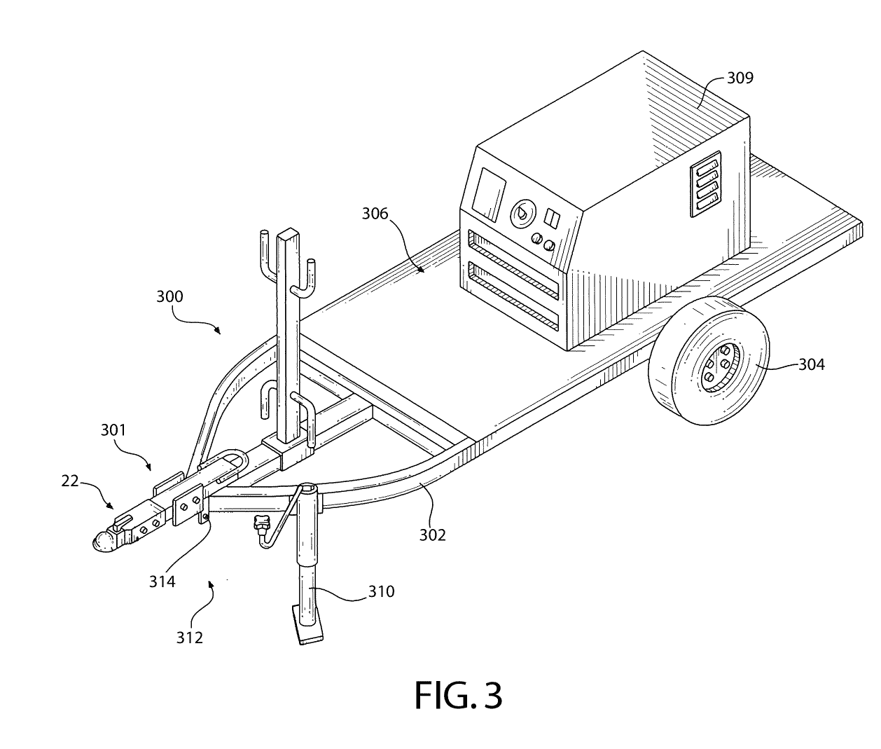

FIG. 3 illustrates a trailer 300 incorporating a trailer hitch or hitching device, depicted generally at 301. The trailer 300 may include a trailer frame 302 and one or more trailer wheels 304 in rotational connection with the trailer frame 302 and may further include a payload region 306 for carrying one or more cargo items, which in an exemplary manner may be a welding power supply 308 or an engine driven welding power supply 308. The trailer 300 may also include an adjustable stand 310 for adjusting the height of the front end 312 of the trailer 300. However, any means may be used for raising and/or lowering the front end 312 of the trailer 300. The trailer hitch 301 may be a generally longitudinal and substantially rigid trailer hitch 301 and may be attached to the frame 302 via fasteners 314, which may be threaded bolts.

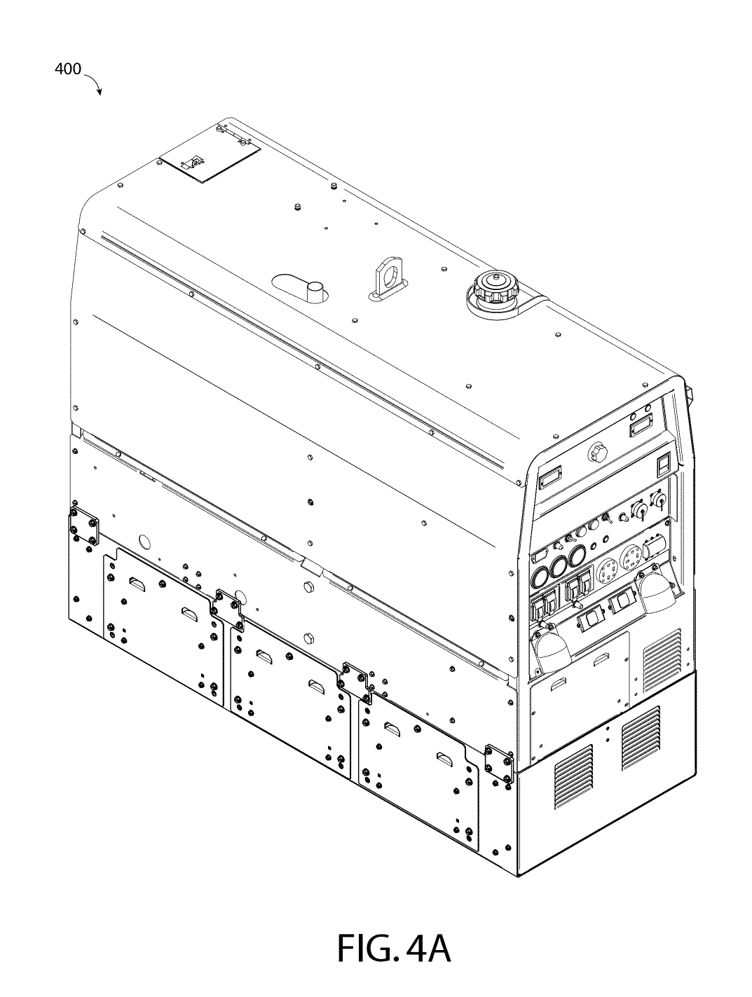

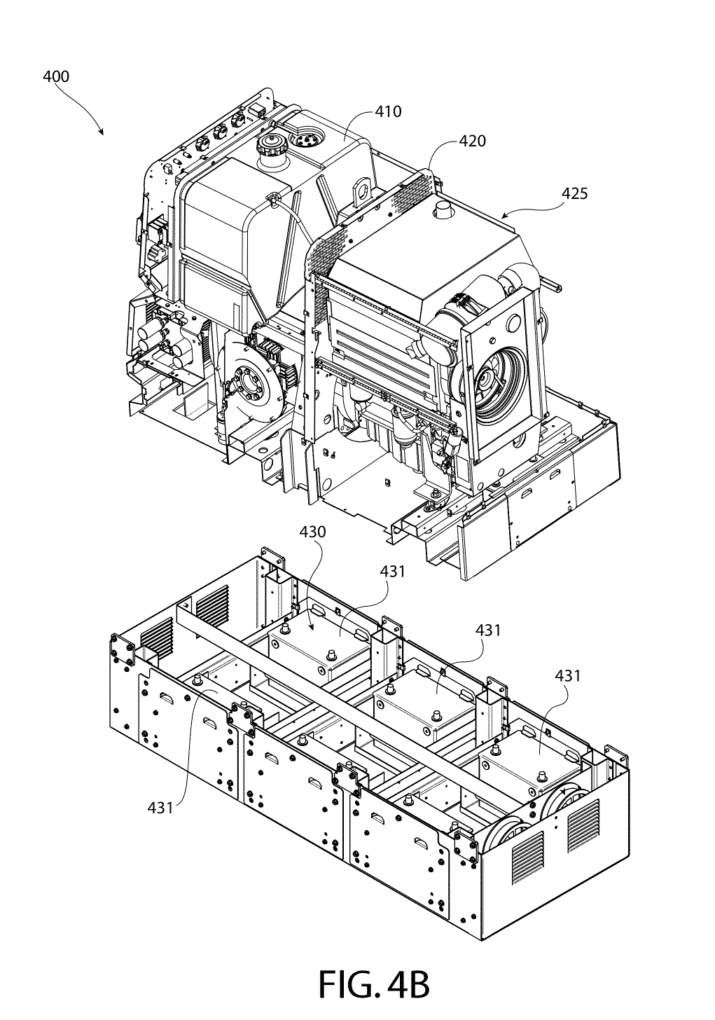

FIGS. 4A and 4B illustrate a hybrid welding device (herein referred to as a “hybrid welder”). A hybrid welder according to the invention is generally indicated by the number 400 in the drawings. Hybrid welder 400 includes an engine component that runs on fuel from fuel storage 410 allowing the hybrid welder 400 to be portable. It will be appreciated that hybrid welder 400 may also be mounted in a permanent location depending on the application. Hybrid welder 400 generally includes a motor-driven welder assembly 420 having a motor 425 and an energy storage device 430. Motor 425 may be an internal combustion engine operating on any known fuel including but not limited to gasoline, diesel, ethanol, natural gas, hydrogen, and the like. These examples are not limiting as other motors or fuels may be used.

The motor 425 and energy storage device 430 may be operated individually or in tandem to provide electricity for the welding operation and any auxiliary operations performed by hybrid welder 400. For instance, the control between motor 425 and energy storage device 430 can be based upon a switch component (not shown), a controller (not shown), a portion of software, a portion of hardware, or a combination thereof. For example, individual operation may include operating the motor 425 and supplementing the power from the motor 425 with power from the energy storage device 430 on an as needed basis. Or supplying power from the energy storage device 430 alone when the motor 425 is offline. Tandem operation may also include combining power from motor 425 and energy storage device 430 to obtain a desired power output. According to one aspect of the invention, a welder 400 may be provided with a motor having less power output than ordinarily needed, and energy storage device 430 used to supplement the power output to raise it to the desired power output level. In an embodiment, a motor with no more than 19 kW (25 hp) output may be selected and supplemented with six 12 volt batteries. Other combinations of motor output may be used and supplemented with more or less power from energy storage device. The above example, therefore, is not limiting.

Energy storage device 430 may be any alternative power source including a secondary generator, kinetic energy recovery system, or, as shown, one or more batteries 431. In an embodiment, six 12 volt batteries 431 are wired in series to provide power in connection with motor-driven welder assembly 420. Batteries 431 shown are lead acid batteries. Other types of batteries may be used including but not limited to NiCd, molten salt, NiZn, NiMH, Li-ion, gel, dry cell, absorbed glass mat, and the like.

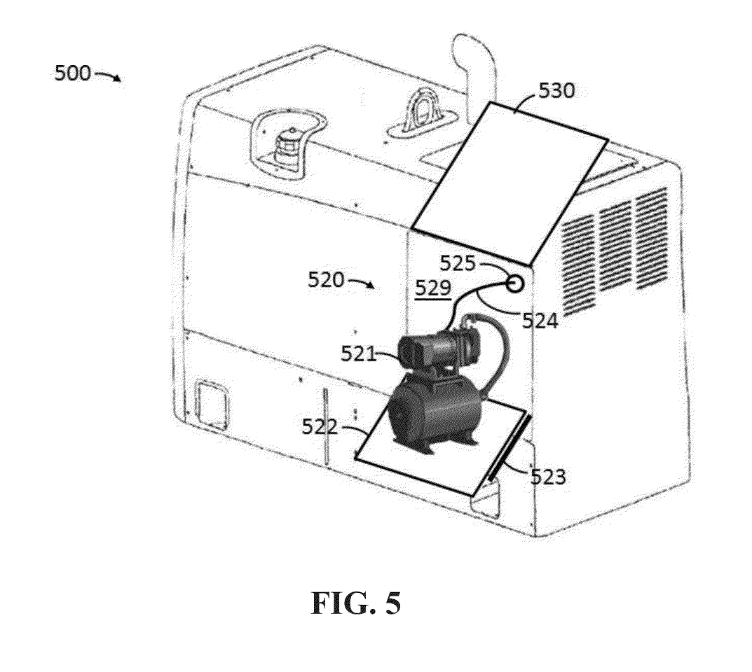

The best mode for carrying out the invention will now be described for the purposes of illustrating the best mode known to the applicant at the time of the filing of this patent application. The examples and figures are illustrative only and not meant to limit the invention, which is measured by the scope and spirit of the claims. Referring now to the drawings, wherein the showings are for the purpose of illustrating an exemplary embodiment of the invention only and not for the purpose of limiting same, FIGS. 5-7 illustrate a schematic block diagram of a welding device, and in particular, an engine driven welding device as discussed in FIGS. 1-4.

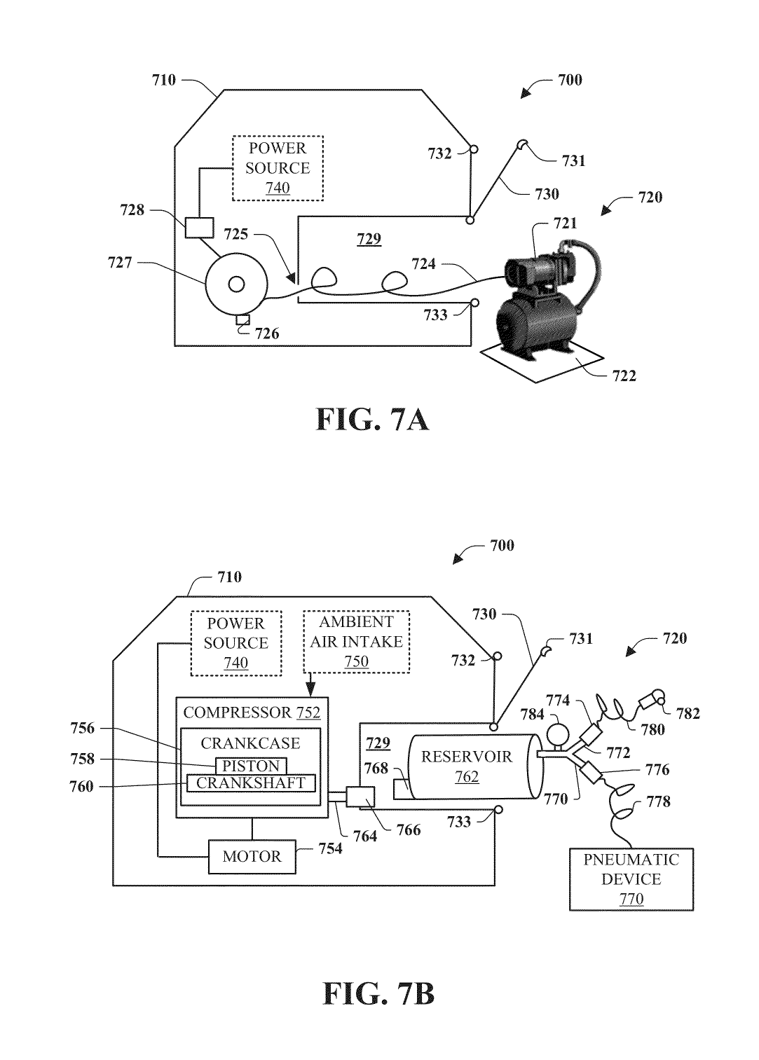

FIG. 5 shows an embodiment of a welder 500 including air compressor system 520. Air compressor system 520 includes compressor 521, which can be stowed in recess 529. Compressor 521 is discussed in more detail in FIG. 7 and can be chosen with sound engineering judgment without departing from the intended scope of coverage of the embodiments of the subject invention. When compressor 521 is stowed in recess 529, access panel 530 can be closed. In embodiments, access panel 530 is flat, and creates a flush closure matching the contours of welder 500 when closed. In other embodiments, access panel 530 can be curved, 3-dimensional, or include a “jog-out”, increasing the closed volume of recess 529 to accommodate the specific geometry of compressor 521. In still other alternative embodiments, access panel 530 can include a hole that allows at least a portion of air compressor system 520 to protrude through access panel 530 when access panel 530 is in a closed state.

Compressor 521 is supported by base 522. In embodiments, base 522 can extend outward from recess 529 to permit easy access to compressor 521 and a secure resting position for compressor 521 when not in use. In embodiments where base 522 can extend outward using support system 523. Support system 523 can include drawer-like rails which telescope or nest when transitioning between an open or closed state. In embodiments, base 522 can be extended or retracted through other mechanisms (e.g., swinging out or in) and can be supported through other mechanisms (e.g., hinges, support cables, legs, stops). In embodiments, base 522 can be cantilevered when extended outward, and support system 523 does not extend beyond the outer edge of welder 500.

Compressor 521 is coupled with retractable cord 524. Retractable cord 524 provides electrical power to compressor 521 for operation. In embodiments, retractable cord 524 can be reinforced to resist damage (e.g., fraying, cutting) and permit use of retractable cord 524 as a tether for compressor 521. Retractable cord 524 can pass through cord aperture 525 to a compartment partitioned from recess 529 where the cord can be kept. Retractable cord 524 can have attached thereto a cord stop (not shown in FIG. 5) that contacts cord aperture 525 or another component to prevent retractable cord 524 from being overextended, damaged, or disconnected from welder 500 or other coupled components.

While air compressor system 520 is shown oriented in a particular area of welder 500, those of skill in the art will appreciate how this orientation is for illustrative purposes only, and that the particular positioning illustrated is only one of many possible configurations under the disclosures here. Further, it is understood that some embodiments of welders may not permit integration of air compressor system 520, due to the location of internal components. Nonetheless, at least one embodiment of welder can be configured to integrate air compressor system 520 as illustrated, and FIG. 5 can provide illustrative detail for integration in other embodiments.

Further, while compressor 521 is shown with retractable cord 524, it is understood that, in alternative embodiments, retractable cord 524 need not be a component of air compressor system 520, and compressor 521 can be a detached and removed from recess 529 (also referred to as a compartment. For instance, compressor 521 can include an energy storage device (not shown) that allows for removal and detachment from recess 529 for use of a compressor. In another instance, compressor 521 can include a detachable reservoir with hose and nozzle such that the reservoir can include compressed air generated by a power source and then used while being removed and detached from welder 500. In some such embodiments, compressor 521 can include a recharging port that mates with a similar port in base 522. In this way, the self-contained battery of a compressor 521 can be recharged using power from welder 500.

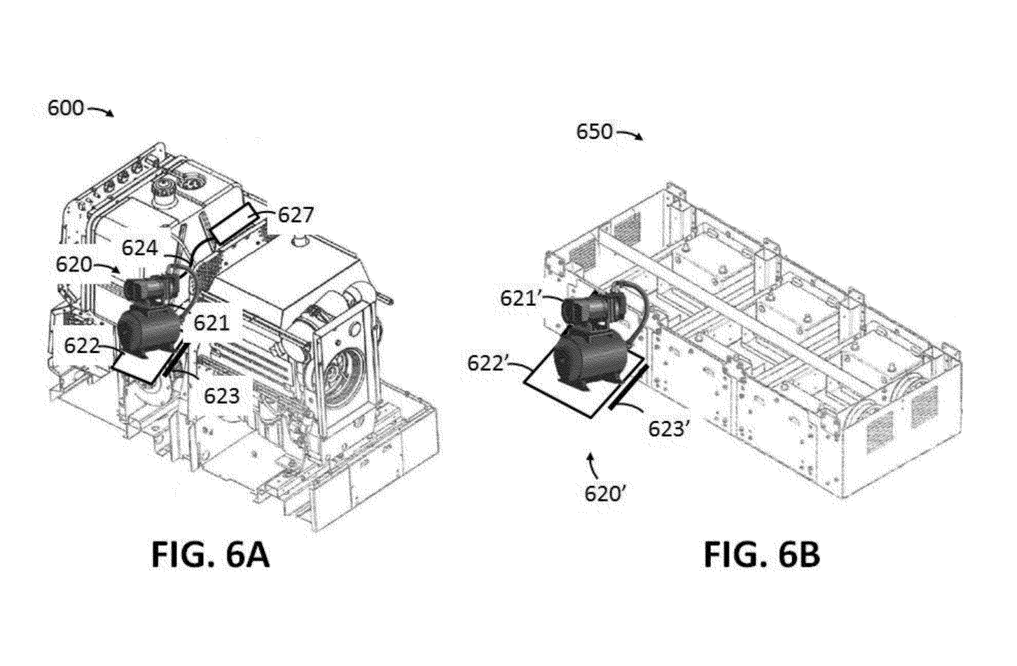

FIGS. 6A and 6B illustrate embodiments of possible placements of an air compressor system in relation to various welding components. FIG. 6A illustrates a hybrid welder 600 with its outer case removed, and FIG. 6B shows an energy storage apparatus 650 for use with hybrid welder 600.

While FIGS. 6A and 6B depict air compressor systems 620 and 620′, respectively, it is understood that when hybrid welder 600 and energy storage apparatus 650 are used in conjunction, only one of air compressor systems 620 and 620′ will be included. Thus, in some embodiments of a hybrid welding system using hybrid welder 600 and energy storage apparatus 650, only one of air compressor system 620 and air compressor system 620′ will be present. Nonetheless, alternative embodiments can include two or more of air compressor system 620, air compressor system 620′, and another tool integrated in a fashion similar to one of air compressor systems 620 and 620′.

FIG. 6A shows hybrid welder 600 decoupled from energy storage apparatus 650 with its motor and fuel storage exposed. Air compressor system 620 can be integrated in a void between the motor and fuel storage, or in another position. As-illustrated between motor and fuel storage, air compressor system 620 can be surrounded by or include heat-resistant materials intended to insulate the air compressor system 620 from motor heat, or conduct heat away from the air compressor system 620.

Air compressor system 620 can include compressor 621, base 622, and base supports 623. Base 622 may extend out of or retract into the space between the motor and fuel storage to improve access to compressor 621 and/or provide a “table” on which to replace compressor 621. Base 622 can be supported or retained in one or both of extended and retracted positions by base supports 623.

Compressor 621 is powered using electricity provided through retractable cord 624. Retractable cord 624 is stored about cord spool 627, which can be manually wound to spool or unspool retractable cord 624, or be biased (e.g., spring-loaded) to automatically spool slack in retractable cord 624. In embodiments, retractable cord 624 need not pass through a cord aperture, and cord spool 627 can be disposed in a position with no physical separation from other components of air compressor system 620.

FIG. 6B shows energy storage apparatus 650 having air compressor system 620′. Air compressor system 620′ includes battery compressor 621′ that is powered by at least a portion of energy stored in an energy storage apparatus 650. Battery compressor 621′ includes a charging port (not shown), which is configured to couple with a base charging port (not shown) on base 622′. In this way, an internal battery for battery compressor 621′ can be recharged when battery compressor 621′ is on base 622′. Base 622′ can be restrained or moved about by way of base supports 623′. In some embodiments, air compressor system 620′ can be placed in a space which may otherwise house a battery or other portion of energy storage apparatus 650.

Bases 622 and 622′ can include strap, clip, retainer, or other securing member (not pictured) to secure compressor 621/621′ when engaged. When a securing member is engaged, hybrid welder 600 and/or energy storage apparatus 650 can be moved without shifting of compressor 621/621′, and compressor 621/621′ is secure and prevented from falling off base 622/622′.

FIGS. 7A and 7B illustrate cutaway views of welding system 700 incorporating air compressor system 720. Welding system 700 includes engine-driven welder 710, which is operatively coupled to power source 740. Power source 740 is used to generate at least a portion of power utilized by engine driven welder 710 and can be, but is not limited to, an energy storage device, a motor, an engine, a combustion engine, among others.

In addition to components utilized with welding tools, engine driven welder 710 includes opening 729, which stores compressor 721 and associated components. Opening 729 is exposed or enclosed depending on the position of door 730. Door 730 can be hingedly attached or fold in an outward or inward direction. In embodiments, door 730 can slide along rails to be opened outside engine driven welder 710, or can slide into a compartment of engine driven welder 710. In hinged and sliding embodiments, door 730 may include multiple portions (e.g., hingedly connected) that allow the door to assume curvature otherwise change its shape during opening or closing. Door 730 can include door latch 731, which can attach to one of latches 732 and 733 to secure door 730 in an open or closed position. In some embodiments, door latch 731 can include a lock to provide security and prevent unauthorized use or removal of compressor 721.

In an embodiment, compressor 721 is electrically powered by retractable cord 724. Retractable cord 724 passes through a partition via cord aperture 725, whereafter spool 727 (or another cord-retention component) retains excess cord not needed to move compressor 721 to a position where it is utilized. Retractable cord 724 can be used in combination with overextension preventer 726, which is fixed to at least one portion of retractable cord 724 and stops in contact with cord aperture 725 or another component to prevent retractable cord 724 from being overextended and separating from spool 727 or power coupler 728. A distal cord end operatively attaches with power coupler 728, which routes appropriate electrical power to retractable cord 724 to power compressor 721. In embodiments, power coupler 728 can include a converter, inverter, fuse, surge protector, or other components that prevent excess electrical power from being routed to and possibly damaging compressor 721.

Compressor 721 can rest on a base. Base includes at least a stowed position and a usage position. Base can slide, roll, or otherwise be moved out of opening 729 to improve access and function of air compressor system 720. Base tracks can support base in one or both of the stowed position and usage position. In some embodiments, base can be machined, molded, or otherwise shaped to accommodate compressor 721 placed on base in one or more positions.

FIG. 7B illustrates welder system 700 that includes welder 710 and air compressor system 720. Air compressor system 720 can be integrated into welder system 700 such that a portion of power used by compressor 752 is provided by welder 710 and in particular power source 740. For instance, welder 710 can include power source 740 as a motor, an engine, an energy storage device, or a combination thereof. Moreover, air compressor system 720 can receive a portion of power via power source 740 to power motor 754 for storing a portion of compressed air in reservoir 762. In another instance, air compressor system 720 can be powered by an energy storage device (not shown but discussed in FIG. 6B) for compressor 752 that is charged by power source 740. Power source 740 and distribution to at least motor 754 (e.g., via an engine, via an energy storage device of welder 710, via energy storage device of compressor 752, or a combination thereof) can be chosen with sound engineering judgment without departing from the intended scope of the subject innovation.

Compressor 752 can receive ambient air via ambient air intake 750 and convert ambient air into compressed air. In particular, motor 754 can drive (e.g., rotate) crankshaft 760 disposed within crankcase 756 that actuates piston 758. Piston 758 can provide suction to draw in a portion of ambient air via ambient air intake 750 and force or compress the portion of ambient air into reservoir 762, wherein the force and compression generate a portion of compressed air. Compressor 752 transfers the portion of ambient air through air line 764 that is connected to reservoir 762 for storage of the converted ambient air (e.g., compressed air). The stored compressed air can be delivered via a hose or nozzle from reservoir 762.

In an embodiment, a regulator component (not shown) manages am amount of pressure stored in reservoir 762. In particular, motor 754 can be controlled based upon the regulator component. Still further, an adjustment device can be utilized to set a desired air pressure for delivery from reservoir 762. For instance, a particular pounds per square inch (PSI) may be desired by a user for use with inflation of a tire, a pneumatic device (e.g., drill, nailgun, wrench, air sprayer, impact wrench, jackhammer, and the like), among others. In another embodiment, gauge 784 is provided to indicate a pressure reading or amount. For instance, gauge 784 can display a pressure of reservoir 762 or a target pressure for delivery of a portion of stored compressed air.

In an embodiment, air compressor system 720 can be detachable and removable from compartment or recess 729. For instance, air compressor system 720 can be modular such that reservoir 762 can be portable in comparison to welder 710. For instance, a coupling mechanism that includes first connector 766 and second connector 768 can allow air line 764 to couple and de-couple to reservoir 762. It is to be appreciated that coupling mechanism allows for receipt of a portion of ambient air from compressor 752 which is stored and converted to compressed air. Reservoir 762 can be removable from welder 710 without any connections to allow for portability and eventually delivery of compressed air. It is to be appreciated reservoir 762 can include one or more handles (not shown) for ease of portability.

In an embodiment, reservoir 762 can include a valve with one or more channels. For example, the valve can be a “Y” shaped valve. In particular, the valve can include a first channel 770 and a second channel 772, wherein first channel 770 provides delivery of compressed air at a first air pressure (via an adjustment device) and second channel 772 provides delivery of compressed air at a second air pressure (via an adjustment device). Further, each channel can include an adjustment device that regulates air pressure delivered from reservoir 762. For example, first channel 770 can include adjustment device 776 that regulates an air pressure of compressed air delivered from reservoir 762 and second channel 772 can include adjustment device 776 that regulates air pressure of compressed air delivery from reservoir 762. For instance, nozzle 782 can be coupled to hose 780 that receives compressed air from reservoir 762 for delivery. The nozzle 782 can deliver compressed air to a tire, a item that requires inflating, and the like. In another example, pneumatic device 770 can be actuated by compressed air delivered via hose 778 from reservoir 762. It is to be appreciated that various couplings, connectors, fittings, and the like can be utilized with the subject innovation and for the sake of brevity have not been discussed but are intended to be within the scope of the subject disclosure.

Welder system 700 further includes controller that is configured to manage electrical current use. In particular, controller can determine to perform a welding operation with power source 740, an energy storage device, energy generated by motor 754, or a combination thereof. For instance, motor 754 can be used to supplement or replace power source 740 for electrical current used with a welding operation. In another embodiment, controller can determine when compressor 752 and/or motor 754 can be operated based on a parameter. For instance, the parameter can be a switch or a user input. By way of example and not limitation, the parameter can be a switch that allows a first setting to activate compressor 752. In the embodiment, the parameter is at least one of a representative of power source 740 of welding system 700 operating, a representative of the welding operation being performed (e.g., welding, brazing, gouging, TIG, etc.), an amount of energy stored in an energy storage device, a fuel amount contained within welding system 700, a cost of a fuel for a motor, a fuel consumption efficiency for welding system 700, a duration of time the motor of welding system 700 operates, a welding parameter (e.g., a voltage, a current, a wire feed speed, a type of weld, a workpiece composition, etc.), and the like.

In another embodiment, controller can determine whether to operate compressor 752 based on a parameter that is a welding parameter. For instance, the welding parameter can be, but is not limited to, a voltage of the welding operation, a current of the welding operation, a portion of a waveform used with the welding operation, a welding schedule parameter (e.g., welding process, wire type, wire size, wire feed speed (WFS), volts, trim, wire feeder to use, feed head to use, among others), a position of a welding tool, a composition of the workpiece on which the welding operation is performed, a position or location of an operator, sensor data (e.g., video camera, image capture, thermal imaging device, heat sensing camera, temperature sensor, among others), an amount of charge stored in energy storage device, a signal from a controller of the welding operation, a signal from a controller associated with welding device, and the like.

In an embodiment, the air compressor system further includes a compressor operable to provide compressed air, and comprising a crankcase and a crankshaft, wherein the crankshaft is disposed in the crankcase and a controller that is configured to power the compressor via the motor based upon at least the regulator component. In an embodiment, a welding device can include an adjustment device that is configured to receive a user setting for a target air pressure for the portion of compressed air stored in the reservoir. In an embodiment, the adjustment device further regulates an air pressure delivered from the reservoir to the hose to the nozzle. In an embodiment, the air pressure delivered from the reservoir to the hose to the nozzle is based upon a pounds per square inch (PSI) for a tire or a pneumatic device.

In an embodiment, a welding device can include an energy storage device that is an additional power source for the welding device to perform the welding operation and a switch component that selects between the energy storage device and the motor. In an embodiment, the air compressor system receives a portion of power from the energy storage device to generate the portion of compressed air in the reservoir. In an embodiment, the air compressor system is powered by the motor or the energy storage device.

In an embodiment, a welding device can include a valve member that includes a first channel for a first portion of compressed air and a second channel for a second portion of air, wherein at least one of the first channel or the second channel include at least one adjustment device to regulate a PSI for delivery of the portion of compressed air via the nozzle. In an embodiment, the first portion of compressed air is a first PSI and the second portion of compressed air is a second PSI. In an embodiment, the first PSI or the second PSI are based upon a user input for a target air pressure.

In an embodiment, a welding device can include a gauge that displays at least one of the amount of the portion of compressed air, a target air pressure for the portion of compressed air stored in the reservoir, or an air pressure delivered upon release of the portion of compressed air from the reservoir. In an embodiment, a welding device can include a compartment that stores the air compressor system. In an embodiment, the hose, the nozzle, and the reservoir are detachable from the welding device with the portion of compressed air stored in the reservoir.

In an embodiment, a welding system can include an energy storage device that is an additional power source for the welding device to perform the welding operation and a switch component that selects between the energy storage device and the motor. In an embodiment, the means for driving the one or more pistons is one of the motor or the energy storage device. For instance, the means for driving the one or more pistons can be a motor of an engine driven welder, an energy storage device associated with an engine driven welder, an energy storage device associated with solely the air compressor system, a motor solely associated with the air compressor system, a combination thereof, a connecting rod for each piston with a crankshaft disposed in a crankcase, and the like. In an embodiment, the means of driving the one or more pistons provides a suction of the portion of ambient air and a compression of the portion of ambient air to become the portion of compressed air. In an embodiment, at least one of the reservoir, the hose, or the nozzle are detachable and removable from the internal compartment.

While the embodiments discussed herein have been related to the systems and methods discussed above, these embodiments are intended to be exemplary and are not intended to limit the applicability of these embodiments to only those discussions set forth herein. The control systems and methodologies discussed herein are equally applicable to, and can be utilized in, systems and methods related to arc welding, laser welding, brazing, soldering, plasma cutting, waterjet cutting, laser cutting, and any other systems or methods using similar control methodology, without departing from the spirit or scope of the above discussed inventions. The embodiments and discussions herein can be readily incorporated into any of these systems and methodologies by those of skill in the art. By way of example and not limitation, a power supply as used herein (e.g., welding power supply, among others) can be a power supply for a device that performs welding, arc welding, laser welding, brazing, soldering, plasma cutting, waterjet cutting, laser cutting, among others. Thus, one of sound engineering and judgment can choose power supplies other than a welding power supply departing from the intended scope of coverage of the embodiments of the subject invention.

The above examples are merely illustrative of several possible embodiments of various aspects of the present invention, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (e.g., that is functionally equivalent), even though not structurally equivalent to the disclosed structure which performs the function in the illustrated implementations of the invention. In addition although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that are not different from the literal language of the claims, or if they include equivalent structural elements with insubstantial differences from the literal language of the claims.

The best mode for carrying out the invention has been described for purposes of illustrating the best mode known to the applicant at the time. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof.

What is claimed is:

1. A welding device, comprising:
a motor-driven welder assembly including a motor that is a power source for the welding device to perform a welding operation;
an air compressor system that generates and stores a portion of compressed air in a reservoir, wherein the air compressor system is powered by at least the motor;
a nozzle coupled to a hose that connects to the reservoir for delivery of the portion of compressed air; and
a regulator component that is configured to manage an amount of the portion of compressed air stored in the reservoir.

2. The welding device of claim 1, wherein the air compressor system further comprises:
a compressor operable to provide compressed air, and comprising a crankcase and a crankshaft, wherein the crankshaft is disposed in the crankcase; and
a controller that is configured to power the compressor via the motor based upon at least the regulator component.

3. The welding device of claim 1, further comprising an adjustment device that is configured to receive a user setting for a target air pressure for the portion of compressed air stored in the reservoir.

4. The welding device of claim 1, wherein the adjustment device further regulates an air pressure delivered from the reservoir to the hose to the nozzle.

5. The welding device of claim 4, wherein the air pressure delivered from the reservoir to the hose to the nozzle is based upon a pounds per square inch (PSI) for a tire or a pneumatic device.

6. The welding device of claim 1, further comprising:
an energy storage device that is an additional power source for the welding device to perform the welding operation; and
a switch component that selects between the energy storage device and the motor.

7. The welding device of claim 6, wherein the air compressor system receives a portion of power from the energy storage device to generate the portion of compressed air in the reservoir.

8. The welding device of claim 7, wherein the air compressor system is powered by the motor or the energy storage device.

9. The welding device of claim 1, further comprising a valve member that includes a first channel for a first portion of compressed air and a second channel for a second portion of air, wherein at least one of the first channel or the second channel include at least one adjustment device to regulate a PSI for delivery of the portion of compressed air via the nozzle.

10. The welding device of claim 9, wherein the first portion of compressed air is a first PSI and the second portion of compressed air is a second PSI.

11. The welding device of claim 10, wherein the first PSI or the second PSI are based upon a user input for a target air pressure.

12. The welding device of claim 1, further comprising a gauge that displays at least one of the amount of the portion of compressed air, a target air pressure for the portion of compressed air stored in the reservoir, or an air pressure delivered upon release of the portion of compressed air from the reservoir.

13. The welding device of claim 1, further comprising a compartment that stores the air compressor system.

14. The welding device of claim 13, wherein the hose, the nozzle, and the reservoir are detachable from the welding device with the portion of compressed air stored in the reservoir.

15. A welding system, comprising:
a motor-driven welder assembly including a motor that is a power source for the welding device to perform a welding operation;
an internal compartment that houses an air compressor system;
the air compressor system that includes:
a reservoir that stores a portion of compressed air;
an intake that receives a portion of ambient air;
a crankcase with one or more pistons;
means for driving the one or more pistons;
a hose with a first end and a second end opposite the first end, the first end is coupled to the reservoir; and
a nozzle coupled to the second end for delivery of the portion of compressed air.

16. The welding system of claim 15, further comprising:
an energy storage device that is an additional power source for the welding device to perform the welding operation; and
a switch component that selects between the energy storage device and the motor

17. The welding system of claim 16, wherein the means for driving the one or more pistons is one of the motor or the energy storage device.

18. The welding system of claim 15, wherein the means of driving the one or more pistons provides a suction of the portion of ambient air and a compression of the portion of ambient air to become the portion of compressed air.

19. The welding system of claim 15, wherein at least one of the reservoir, the hose, or the nozzle are detachable and removable from the internal compartment.

20. A system, comprising:
a trailer incorporating a trailer hitch, a trailer frame, and a payload region;
an adjustable stand on a front end of the trailer, wherein the adjustable stand is configured to adjust a height of the front end of the trailer;
an engine driven welder secured to the payload region;
a motor-driven welder assembly including a motor that is a power source for the engine driven welder to perform a welding operation;
an internal compartment that houses an air compressor system;
the air compressor system that includes:
a reservoir that stores a portion of compressed air,
an intake that receives a portion of ambient air,
a crankcase with one or more pistons,
means for driving the one or more pistons; and
means for delivering the portion of compressed air for inflation of a tire or driving a pneumatic device.
